(19) United States
(12) Patent Application Publication
(10) Pub. No.: US 2002/0105797 A1
(43) Pub. Date: Aug. 8, 2002

(54) Tool light and method of use

(75) Inventors: Amir A. Navid, Tarzana, CA (US); Eric A. Hanscom, Los Angeles, CA (US); David Naghi, Los Angeles, CA (US)

Correspondence Address: STEPHEN C. BEUERLE, PROCOPIO, CORY, HARGREAVES & SAVITCH, 530 B STREET, SUITE 2100, SAN DIEGO, CA, 92101-4469, US

(73) Assignee: Technology Creations, Inc., Los Angeles, CA (US)

(21) Appl. No.: 09/846,503

(22) Filed: Apr. 30, 2001

Related U.S. Application Data
(63) Continuation-in-part of application No. 09/778,251, filed on Feb. 6, 2001.

(51) Int. Cl. B25B 23/18

(52) U.S. Cl. 362/120; 362/119; 362/191; 362/397; 362/396

(57) ABSTRACT

A tool light and method of using the same for illuminating a work area for a tool. The tool light includes a mounting mechanism to be mounted to at least one of a support surface of the tool and a support surface in the vicinity of the tool, and a light housing carried by the mounting mechanism. The light housing has at least one LED and at least one power source to power at least one LED to illuminate a work area for a tool. The method includes mounting the mounting mechanism to at least one of a support surface of the tool and a support surface in the vicinity of the tool, and illuminating the work area with at least one LED of the tool light.

### CROSS-REFERENCE TO RELATED APPLICATION RELATE BACK INFORMATION

This is a continuation-in-part application of pending prior application Ser. No. 09/778,251, filed on Feb. 6, 2001.

### FIELD OF THE INVENTION

The present invention is in the field of lighting devices for illuminating the work area for a tool.

### BACKGROUND OF THE INVENTION

It is often desirable to use a tool such as screwdriver inside a cabinet, attic, or other tight location where inadequate lighting exists. A flash light or drop light may be used to provide lighting in some circumstances, but in tight spots, neither of these lights will work, if an extra hand is not available, a flashlight may not work, and if an AC power source is not available, a drop light will not work.

Also, use of a flashlight in one hand while operating a hand tool with another, particularly when the hand tool is normally operated with two hands, e.g., power drill, may be dangerous. Further, as is frequently done, when a flashlight is balanced on a shelf or other support surface not intended to support a flashlight and the flashlight tips over or shifts positions, the tool user's lighted view can be suddenly terminated as the flashlight moves away, creating an inherently dangerous situation where the user is now using a potentially dangerous hand or power tool in inadequate lighting conditions.

U.S. Pat. Nos. 5,038,481, 5,348,359, and 5,525,842 disclose lighting devices for lighting the work area for a saber saw, a retriever tool, and an air tool, respectively. A problem with these lighting devices is that they are not readily mountable to a variety of different tools.

Accordingly, a need exists for a simple tool light that is readily mountable to a variety of different tools and that illuminates the working area for the tool, even in tight working conditions.

### SUMMARY OF THE INVENTION

The present invention is generally directed to a tool light and method of use that may be used with a variety of different tools.

An additional aspect of the invention involves a tool light for illuminating a work area for a tool. The tool light includes a mounting mechanism to be mounted to at least one of a support surface of the tool and a support surface in the vicinity of the tool, and a light housing carried by the mounting mechanism. The light housing has at least one LED and at least one power source to power at least one LED to illuminate a work area for a tool. The light housing may be used with a variety of different mounting mechanisms and the tool light is readily mountable to a variety of different tools and support surfaces.

Another aspect of the invention involves a method of illuminating a work area for a tool. The method includes providing a light housing and a mounting mechanism, the light housing includes at least one LED and is carried by the mounting mechanism; mounting the mounting mechanism to at least one of a support surface of the tool and a support surface in the vicinity of the tool; and illuminating the work area with at least one LED of the tool light.

Further objects and advantages will be apparent to those skilled in the art after a review of the drawings and the detailed description of the preferred embodiments set forth below.

### BRIEF DESCRIPTION OF THE DRAWINGS

FIG. 1 is a side-elevational view of an embodiment of a tool light mounted to a shaft of a screwdriver.

FIG. 2 is an end view of the tool light illustrated in FIG. 1.

FIG. 3 is an end view of a tool light constructed in accordance with an additional embodiment of the invention.

FIG. 4 is a side-elevational view of another embodiment of a tool light mounted to a screwdriver.

FIG. 5 is a side-elevational view of a further embodiment of a tool light mounted to a screwdriver.

FIG. 6 is an end view of the tool light illustrated in FIG. 5.

FIG. 7 is a side-elevational view of a still further embodiment of a tool light that may be mounted to a screwdriver.

FIG. 8 is a perspective view of an embodiment of a light housing of a tool light that may be used with a variety of different mounting mechanisms.

FIG. 9 is an exploded view of the light housing illustrated in FIG. 8.

FIG. 10 is a front elevational view of a mounting mechanism constructed in accordance with an embodiment of the invention.

FIG. 11 is a perspective view of an embodiment of a tool light including the light housing of FIG. 8 and the mounting mechanism of FIG. 10 mounted to an arm of a pair of pliers.

FIG. 12 is a perspective view of another embodiment of a tool light including the light housing of FIG. 8 and another embodiment of a mounting mechanism mounted to a shaft of a screwdriver.

FIG. 13 is a perspective view of an additional embodiment of a tool light including the light housing of FIG. 8 and an additional embodiment of a mounting mechanism mounted to a shaft of a screwdriver.

FIG. 14 is a side-elevational view of the mounting mechanism illustrated in FIG. 13.

FIG. 15 is a side-elevational view of an embodiment of a mounting mechanism similar to the mounting mechanism illustrated in FIG. 14, except the mounting mechanism includes an embodiment of a rotatable light housing support.

FIGS. 16 and 17 are side-elevational views of an embodiment of a mounting mechanism similar to the mounting mechanism illustrated in FIG. 15, except the mounting mechanism includes an alternative embodiment of a mounting member.

FIG. 18 is a side-elevational view of an embodiment of a mounting mechanism similar to the mounting mechanism illustrated in FIG. 15, except the mounting mechanism includes a further embodiment of a mounting member.

FIG. 19 is a side-elevational view of an embodiment of a mounting mechanism similar to the mounting mechanism illustrated in FIGS. 16 and 17, except the mounting mechanism further includes a strap to assist in mounting the mounting mechanism to a support surface.

FIG. 20 is a side-elevational view of an embodiment of a mounting mechanism similar to the mounting mechanism illustrated in FIG. 18, except the mounting mechanism further includes a strap to assist in mounting the mounting mechanism to a support surface.

### DETAILED DESCRIPTION OF PREFERRED EMBODIMENTS

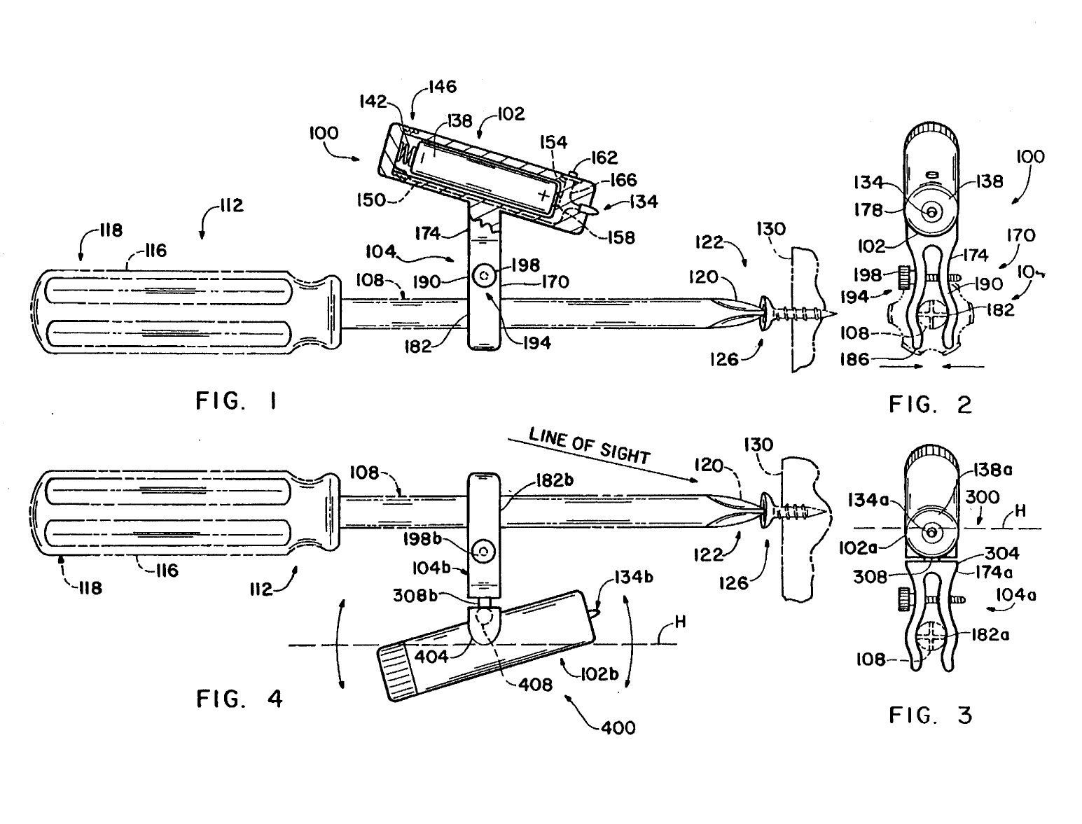

With reference to FIGS. 1 and 2, a tool light 100 constructed in accordance with an embodiment of the invention will now be described. The tool light 100 includes a light housing 102 carried by a mounting mechanism 104. The mounting mechanism 104 is used to mount the tool light 100 to a shaft 108 of a tool such as a screwdriver 112. Although the shaft 108 is shown as an elongated, circular shaft, the shaft 108 may have other lengths and configurations. For example, but not by way of limitation, the shaft 108 may have a square cross-section.

The screwdriver 112 includes a handle 116 at one end 118 of the shaft 108 and a head 120 at an operative or working end 122 of the shaft 108. In the embodiment shown, the screwdriver 112 is a cross-headed tip (e.g., Phillips) screwdriver. The screw driver 112 may be used to screw a screw 126 into a surface 130. Although the illustrated tool is a cross-headed tip screwdriver 112, the tool light 100 may be applied to shafts of tools other than the cross-headed tip screwdriver such as, but not by way of limitation, a flat-tip screwdriver, a square-headed tip screwdriver, other types of screwdrivers, a power drill, a chisel, a caulking gun, a soldering torch, a soldering gun, a cutting torch, a welding torch, and a voltage tester.

The light housing 102 is preferably cylindrical and houses a light source 134 and a power source 138. The light source 134 is preferably one or more wide-angle (i.e., 40 degrees or greater), white LEDs; however other light sources, e.g., incandescent light bulbs, other angle LEDs, other types of LEDs, e.g., flat, pointed, and other color LEDs may be used. In the embodiment shown, the power source 138 is preferably a single AA, AA, or AAAA battery. In alternative embodiments, power sources other than batteries, e.g., miniature fuel cells, different types of batteries, e.g., rechargeable batteries, flat watch batteries such as alkaline 625 cells and NiCd batteries, and different numbers of batteries, e.g., two or more may be used.

A contact spring 142 may be located in a proximal portion 146 of the housing 102 for contacting the negative terminal of the battery 138. A first electrical coupling 150 may connect the contact spring 142 to the LED 134. A second electrical coupling 154 may connect a positive terminal contact 158 to an electrical on/off switch 162. A third electrical coupling 166 may connect the switch 162 to the LED 134. In an alternative embodiment, the electrical circuitry may include a motion sensor mechanism to activate the LED 134 when motion is detected and deactivate the LED 134 when no motion occurs for a prolonged period of time. The electrical circuitry may also include a dimmer mechanism, e.g., variable resistor, for controlling the intensity of the emitted light from the LED 134.

The mounting mechanism 104 may include a dual-collar member 170. The member 170 may include a first collar 174 that carries the light housing 102 at a predetermined or adjustable angle. The light housing 102 may be connected within the first collar 174 by a pair of spot welds 178 or by another connecting means. A second collar 182 receives the shaft 108 of the screwdriver 112. The second collar 182 may come in a variety of different sizes for accommodating different-sized shafts, tools. The second collar 182 includes an open end 186. The dual-collar member 170 includes an intermediate section 190. The intermediate section 190 may include a tightening mechanism 194 for increasing the holding force of the second collar 182 on the shaft 108 in the direction of the arrows shown in FIG. 2. The tightening mechanism 194 may include a threaded fastener 198 that is threadingly engaged within holes in the intermediate section 190.

The tool light 100 will now be described in use. The tool light 100 is mounted or applied to the shaft 108 of the screwdriver 112 by inserting the head 120 of the screwdriver 112 through the second collar 182 and sliding the tool light 100 forward or rearward on the shaft 108 to a position where the working end 122 of the screwdriver 112 and/or the working area is optimally lit by the light source 134, i.e., the light is optimally focused. Alternatively, the second collar 182 may be clamped onto the shaft 108 by snapping the collar 182 onto the shaft 108 through the open end 186 of the second collar 182. The light source 134 is activated by moving the switch 162 to an “on” position and deactivated by moving the switch 162 to an “off” position. The tool light 100 may be slid forward or rearward on the shaft 108 to a position where the working end 122 of the screwdriver 112 and/or the working area is optimally lit by the light source 134. When the tool light 100 is located in a desired position, the tightening mechanism 194 may be actuated to secure the tool light 100 to the shaft 108 by rotating and tightening the threaded fastener 198 in a clockwise direction. The tool light 100 may be removed from the shaft 108 of the screwdriver 112 by rotating and loosening the threaded fastener 198 in a counterclockwise direction. The tool light 100 may then be mounted to a different tool in the same manner as that described above or stored for later use.

With reference to FIG. 3, a tool light 300 constructed in accordance with an additional embodiment of the invention will now be described. Elements similar to those described above with respect to FIGS. 1 and 2 are identified with like reference numerals, but with an “a” suffix. The tool light 300 is similar to the tool light 100 described above with respect to FIGS. 1 and 2, except the light housing 102a is rotatably attached to the mounting mechanism 104a. The first collar 174a may include a support 304 that rotatably receives a rotating pin 308. The rotating pin 308 supports the light housing 102a for general rotation of the light housing 102a with the pin 308 in a horizontal plane H.

Use of the tool light 300 is similar to that described above for the tool light 100, except the light housing 102a may be additionally rotated in a horizontal plane for adjusting the orientation of the light source 134a to an optimal condition for lighting the work area.

With reference to FIG. 4, a tool light 400 constructed in accordance with another embodiment of the invention will now be described. Elements similar to those described above with respect to FIGS. 1-3 are identified with like reference numerals, but with a “b” suffix. The tool light 400 is similar to the tool light 300 described above with respect to FIG. 3, except a rotating support 404 is rotatably mounted to the mounting mechanism 104b by rotating pin 308b for general rotation of the light housing 102b in horizontal plane H. The light housing 102b is pivotally mounted to the support 404 through a pin 408 for pivotal movement of the light housing 102b in a vertical plane in the direction shown by the arrows.

Use of the tool light 400 is similar to that described above for the tool light 300, except the light housing 102b may be additionally rotated in a vertical plane in the direction of the arrows for adjusting the orientation of the light source 134b. In this embodiment (and the embodiment described with respect to FIGS. 1 and 2), the mounting mechanism 104b may be attached to the shaft 108 so that the light housing 102b is below the screwdriver 112. The mounting mechanism 104b may be loosely attached to the shaft 108 so that the tool light 400 hangs from the shaft 108, but does not rotate therewith during rotation of the screwdriver 112. The collar 182b may include bearings or a similar mechanism that allow the tool light 400 to hang from the screwdriver 112 to illuminate the working end 120 and/or working area while the shaft 108 freely rotates within the collar 182b, without the tool light 400 rotating with rotation of the shaft 108.

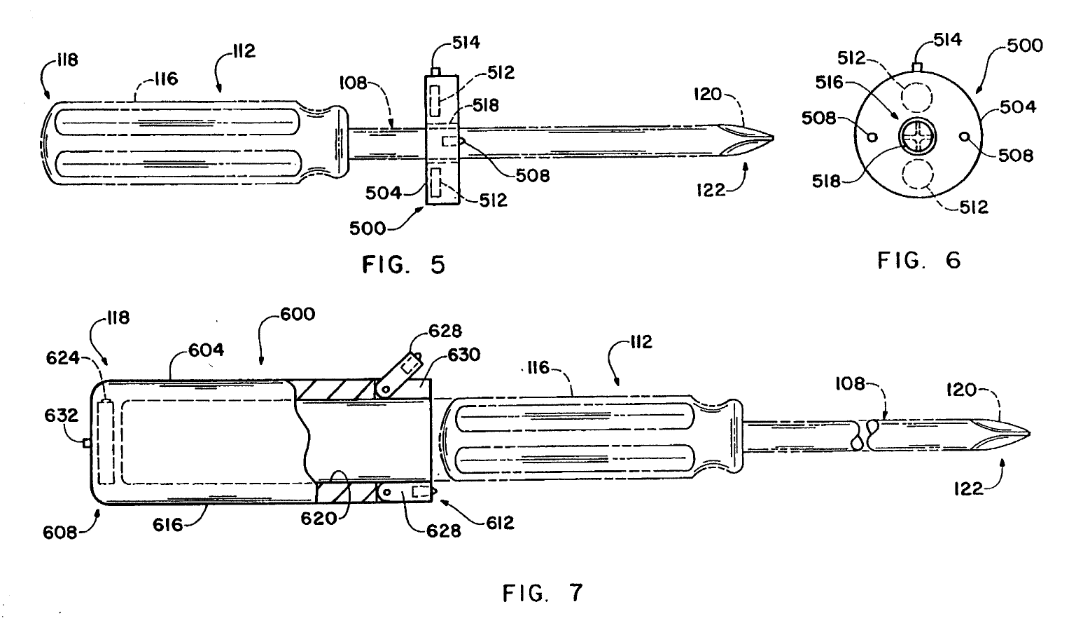

With reference to FIGS. 5 and 6, a tool light 500 constructed in accordance with a further embodiment of the invention will be described. The tool light 500 includes a ring-shaped light housing 504 that houses one or more light sources 508 and one or more power sources 512. In the embodiment shown, the one or more light sources 508 include a pair of LEDs oriented 180 degrees apart from each other and the one or more power sources 512 include a pair of watch batteries oriented 180 degrees apart from each other. The power sources 512 are offset 90 degrees from the light sources 508. The LEDs 508 may be angled inwardly, towards the center of the tool light 500. Electrical circuitry (not shown) connects the power sources 512 to the light sources 508 for powering the light sources 508. The electrical circuitry may include an on/off switch 514 for turning the light sources 508 on or off. In an alternative embodiment, the electrical circuitry of the tool light 500 may include a motion sensor mechanism to activate the light sources 508 when motion is detected and deactivate the light sources 508 when no motion occurs for a prolonged period of time. The electrical circuitry may also include a dimmer mechanism, e.g., variable resistor, for controlling the intensity of the emitted light from the light source(s) 508. A mounting mechanism 516 is located in a central portion of the tool light 500. In the embodiment shown, the mounting mechanism 516 is a flexible rubber grommet 518.

The tool light 500 will now be described in use. The shaft 108 of the screwdriver 112 is slidably inserted through the rubber grommet 518 of the tool light 500 until the tool light 500 a located at a desired longitudinal position on the shaft 108. If the LEDs 508 are angled inwardly, adjusting the longitudinal position of the tool light 500 changes the light focus on the working area. As a result, the tool light 500 may be used on a variety of different length tool shafts simply by adjusting the longitudinal position of the tool light 500 on the shaft for optimal light focusing. The rubber grommet 518 is flexible enough to accommodate different diameter and/or shaped shafts 108, while providing sufficient frictional resistance to hold the tool light 500 to the shaft 108. In alternative embodiments, replaceable rubber grommets 518 or different tool lights 500 having different inner diameters may accommodate different diameter and/or shaped shafts 108. The tool light 500 is activated and deactivated through the on/off switch 514 and/or through the motion detection mechanism. The tool light 500 preferably rotates with rotation of the shaft 108. In an alternative embodiment, an annular bearing mechanism may be located between the rubber grommet 108 and the inner central surface of the annular housing 504 so that the rubber grommet 108, but not the tool light 108, rotates with rotation of the shaft 108.

With reference to FIG. 7, a tool light 600 constructed in accordance with a still further embodiment of the invention will be described. The tool light 600 includes a cylindrical plastic or rubber sleeve 604. The sleeve 604 includes a proximal end 608, a distal end 612, and an elongated, ring-shaped wall 616. The wall 616 include an inner surface 620. The proximal end 608 may house one or more power sources 624 such as, but not limited to, one or more watch batteries. The distal end 612 may carry one or more retractable light sources 628, e.g. LED(s), in recessed areas 630. Each retractable light source 628 may be pivotally connected to the wall for pivotal movement between an outwardly pivoted or “on” position and a retracted or “off” position. Electrical circuitry (not shown) connects the power source 624 to the light sources 628 for powering the light sources 628. The electrical circuitry may include an on/off switch 632 for turning the light sources 628 on or off. In an alternative embodiment, the electrical circuitry of the tool light 600 may include a motion sensor mechanism to activate the light sources 628 when motion is detected and deactivate the light sources 628 when no motion occurs for a prolonged period of time. The electrical circuitry may also include a dimmer mechanism, e.g., variable resistor, for controlling the intensity of the emitted light from the light source(s) 628. Further, pivoting the light sources 628 to the outward position may automatically activate the light sources 628 and retracting the light sources 628 may automatically deactivate the light sources 628.

In use, the cylindrical sleeve 604 of the tool light 600 is slid over the handle 116 of the screwdriver 112, and the light sources 628 are actuated by pivoting them to the outward position, switching the on/off switch 632, and/or by automatic motion detection. When the light sources 628 are not in use, they may pivoted to a retracted or “off” position so that the light sources 628 are flush with the wall 604. During use, the tool light 600 rotates with rotation of the screwdriver 112.

In further embodiments, the features described above with respect to FIG. 7 may be incorporated into the handle 116 of the screwdriver or the light sources 628 may be fixed relative to the sleeve 604 or handle 116 (if incorporated into the handle 116).

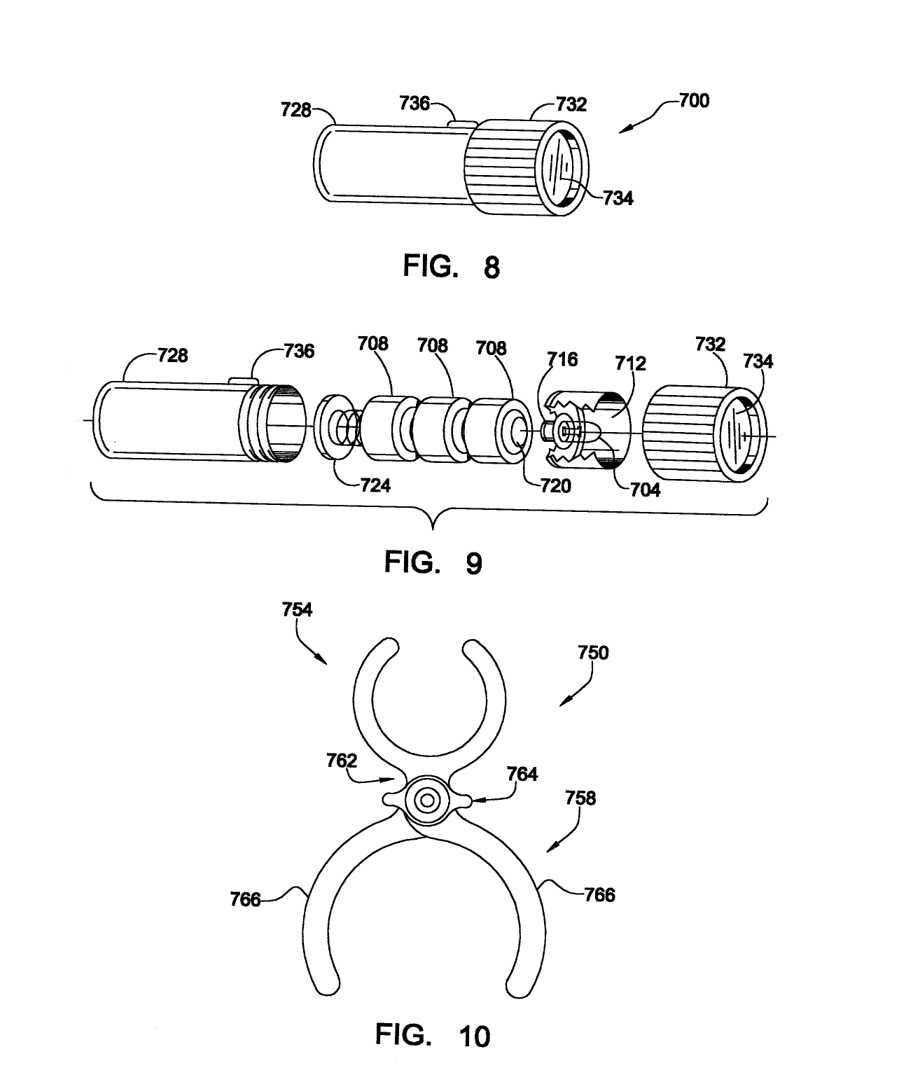

With reference to FIGS. 8 and 9, an embodiment of a light housing 700 of a tool light that may be used with a variety of different mounting mechanisms will now be described. The light housing 700 is preferably cylindrical and houses a light source 704 and one or more power sources 708.

The light source 704 is preferably one or more wide-angle (i.e., 40 degrees or greater), white LEDs; however, other light sources, e.g., incandescent light bulbs, other angle LEDs, other types of LEDs, e.g., flat, pointed, and/or other color LEDs may be used. The light source 704 is carried within a lens mirror dish 712.

In the embodiment shown, the one or more power sources 708 are three stacked watch or flat-type batteries. In alternative embodiments, power sources other than batteries (e.g., miniature fuel cells), different types of batteries (e.g., a rechargeable battery, an AA battery, an AA battery, an AAA battery, an AAAA battery), and/or different numbers of batteries (e.g., one, two, four, etc.), may be used.

A contact 716 of the light source 704 may electrically contact a positive terminal 720 of one of the batteries 708. At an opposite end of the housing 700, a contact spring 724 may contact a negative terminal of one of the batteries 708. The housing 700 includes a cylindrical body 728 and an adjustable light head 732. The adjustable light head 732 preferably includes a lens 734 and may be threadably attached to the body 728 for adjusting the focus of light emitted from light source 704. A switch 736 may be used to turn the light source 704 on and off.

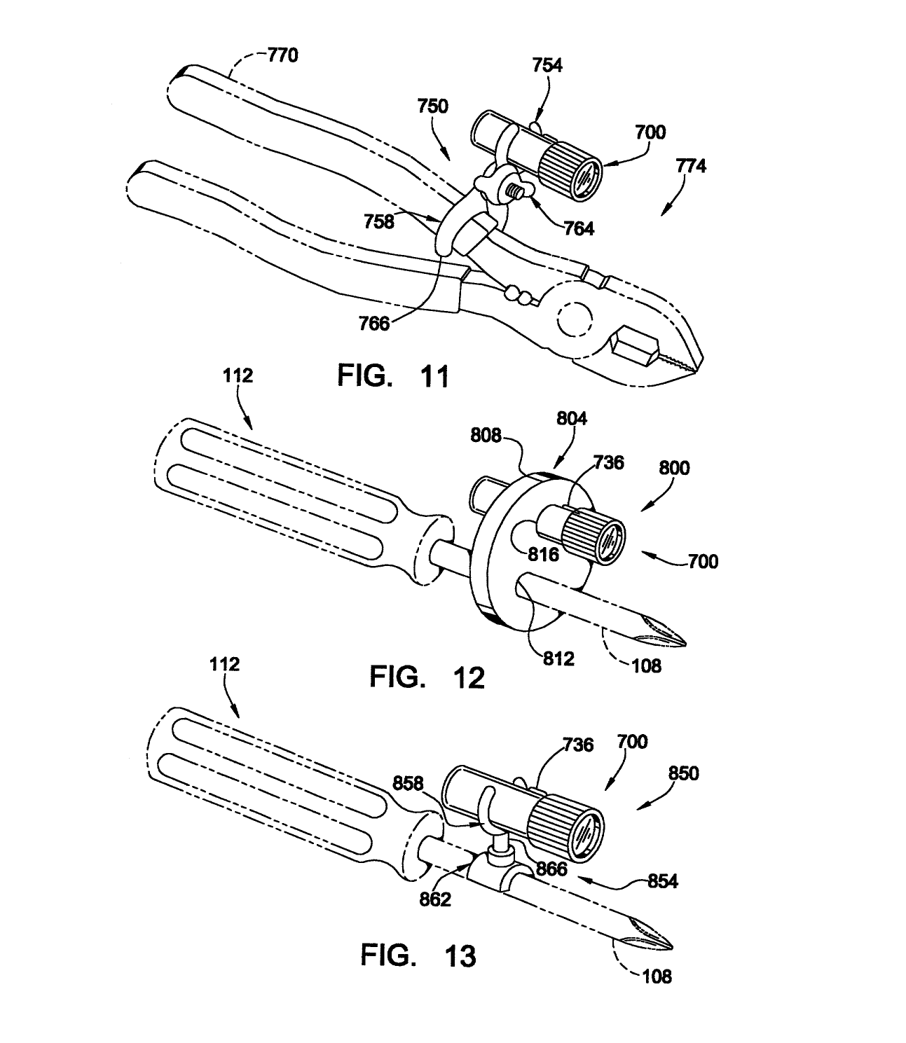

With reference to FIGS. 10 and 11, an embodiment of a mounting mechanism 750 that may carry the light housing 700 will now be described. The mounting mechanism 750 is one of numerous mounting mechanisms that the light housing 700 may be used with. Exemplary embodiments of only a few of such mounting mechanisms are shown and described herein. Together, the light housing 700 and the mounting mechanism 750 form a tool light that is readily mountable to a variety of different tool support surfaces and/or other support surfaces in the vicinity of the work area for lighting a working area while using a tool.

The mounting mechanism 750 has a dual-collar construction. A penannular first collar or light housing support 754 is shaped to carry the cylindrical light housing 700. An adjustable penannular second collar or mounting member 758 is adapted to be attached to a shaft, handle, or other support structure of a tool and/or a support structure in the vicinity of the work area. An intermediate section 762 of the mounting mechanism 750 includes a threaded fastener mechanism (e.g., bolt, washer, wing nut) 764 for adjusting a pair of arms 766 of the second collar 758.

With reference specifically to FIG. 11, in use, the mounting mechanism 750 is mounted to a tool support surface or other support surface in the vicinity of the work area such as, but not by way of limitation, an arm 770 of a pair of pliers 774. This is accomplished by either sliding the second collar 758 longitudinally with respect to the arm 770, over the arm 770, or sliding the second collar 758 laterally with respect to the arm 770, over the arm 770. The threaded fastener mechanism 764 is then tightened, causing the arms 766 of the second collar 758 to clamp against the arm 770 of the pliers 774 and hold the mounting mechanism 750 in place. After, during, or before the mounting mechanism 750 is mounted to the arm 770, the light housing 700 may be slid or snapped into the first collar 754. The light source 704 is activated or deactivated using the light switch 736.

With reference to FIG. 12, another embodiment of a tool light 800 will be described. The tool light 800 includes the light housing 700 illustrated in FIGS. 8 and 9 and another embodiment of a mounting mechanism 804, which is mountable to the shaft 108 of the screwdriver 112. The mounting mechanism 804 is a flexible, wheel-shaped rubber grommet 808 including a shaft-receiving hole 812 and a housing-receiving hole 816. In an alternative embodiment, the grommet 808 may have other shapes (e.g., rectangular, square, elliptical) and/or may be mounted to support surfaces other than the shaft 108 of the screwdriver 112. Both holes 812, 816 preferably have diameters less than the diameters of the screwdriver shaft 108 and the light housing 700, respectively. In an alternative embodiment, the shaft-receiving hole 812 may have a diameter larger than the shaft 108 of the screwdriver 112, allowing the shaft 108 to rotate without rotating the mounting mechanism 804. Although both holes 812, 816 are shown off-center, in an alternative embodiment, one of the holes 812, 816, preferably the shaft-receiving hole 812, may be located near the center of the grommet 808.

In use, the mounting mechanism 804 is mounted to the screwdriver 112 by inserting the shaft 108 through the shaft-receiving hole 812 and the light housing 800 is inserted through the housing-receiving hole 816, but not necessarily in that order. The light source 704 is actuated using the light switch 736. During use of the screwdriver 112, the light housing 108 may rotate with rotation of the shaft 108 to illuminate the work area distal of the screwdriver tip. In the alternative embodiment described above, where the shaft-receiving hole 812 has a larger diameter than the diameter of the shaft 108, the shaft 108 may be rotated without causing the mounting mechanism 804 to rotate.

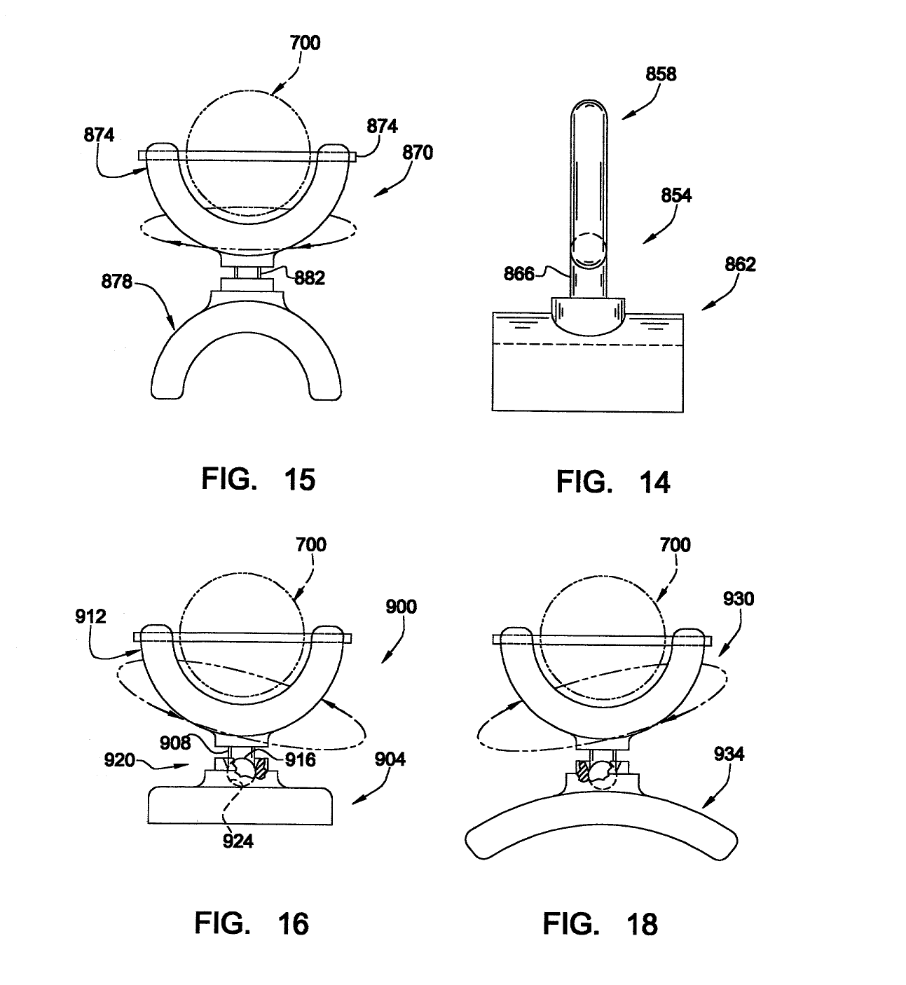

With reference to FIGS. 13 and 14, an additional embodiment of a tool light 850 will be described. The tool light 850 includes the light housing 700 illustrated in FIGS. 8 and 9, and another embodiment of a mounting mechanism 854, which may be mounted to a support surface such as the shaft 108 of the screwdriver 112. The mounting mechanism 854 includes a dual-collar construction. A penannular first collar or light-housing support surface 858 is shaped to carry the cylindrical light housing 700. A penannular second collar or mounting member 862 is a magnet (or includes a magnetic portion) that attaches to a magnetically attractable curved support surface such as, but not by way of limitation, the steel shaft 108 of the screwdriver 112. An intermediate arm section 866 connects the collars 858, 862.

In use, the mounting mechanism 858 is mounted to the steel shaft 108 of the screwdriver 112. This is accomplished by placing a magnetic inner surface of the second collar 862 against a surface of the shaft 108 and sliding the mounting mechanism 854 longitudinally to a desired location along the shaft 108. After, during, or before the mounting mechanism 858 is mounted to the shaft 108, the light housing 700 may be slid or snapped into the first collar 858. The light source 704 is activated or deactivated using the light switch 736.

With reference to FIGS. 15-20, a number of alternative embodiments of a mounting mechanism of a tool light, which are similar to the mounting mechanism 854 described with respect to FIGS. 13 and 14, will now be described.

FIG. 15 is a side-elevational view of another embodiment of a mounting mechanism 870 of a tool light. The mounting mechanism 870 is similar to the mounting mechanism 854 illustrated in FIGS. 13 and 14, except a first collar or light-housing support 874 is rotatably coupled to a magnetic second collar or mounting member 878 through a rotational shaft 882 for rotation of the light housing 700 in a horizontal plane. Further, the first collar 874 carries a pin 874 for pivotally connecting the light housing 700 to the first collar 874 for pivotal movement of the light housing 700 in a vertical plane.

In use, the magnetic second collar 878 is connected to a magnetically attractable support surface such as, but not by way of limitation, the steel screwdriver shaft 108 described above with respect to FIGS. 13 and 14. The light source 704 is activated or deactivated through the switch 736. Further, the light housing 700 may be pivoted relative to the first collar 874 of the mounting mechanism 870 for vertical adjustment of the light housing 700 and/or rotated relative to the second collar 878 for horizontal adjustment of the light housing 700 to orient the light housing 700 for optimal illumination of a work area.

With reference to FIGS. 16 and 17, a further embodiment of a mounting mechanism 900 will be described. The mounting mechanism 900 is similar to the mounting mechanism described above with respect to FIG. 15, except the second collar of FIG. 15 is replaced with a generally flat magnetic base member or mounting member 904. Further, a rotational shaft 908 extending from a first collar or light-housing support 912 terminates at one end in a ball 916 of a ball-and-socket joint 920. A socket 924 receives the ball 916 of the shaft 908. Use of the mounting mechanism 900 is similar to use of the mounting mechanism 870 described with respect to FIG. 15, except the magnetic base member 904 includes a flat magnetic inner surface that is attached to a flat magnetically attractable support surface and the ball-and-socket joint 920 allows the light housing to be pivoted to any of a wide variety of positions (See FIG. 17).

FIG. 18 illustrates an embodiment of a mounting mechanism 930 similar to the mounting mechanism 900 described with respect to FIGS. 16 and 17, except the flat magnetic base member 904 is replaced with a slightly curved magnetic base member 934 for magnetically mounting the mounting mechanism 930 to a slightly curved support surface. Although not shown, other magnetic base members having configurations other than those shown herein may be used for mounting the mounting mechanism of the tool light to a variety of different magnetically attractable support surfaces.

FIG. 19 illustrates an embodiment of a mounting mechanism 930 similar to the mounting mechanism 900 illustrated in FIGS. 16 and 17, except the mounting mechanism 930 further includes a strap 934 to assist in mounting the mounting mechanism 930 to a support surface. The mounting mechanism 930 includes a generally flat magnetic base member 938 with first and second strap holders 942, 946, respectively. The strap 934 is attached at a first end 950 to the first strap holder 942 and looped though the second strap holder 946. Opposite hook fasteners 960 and loop fasteners 966 may be provided on opposing surfaces of the strap 934 for adjusting the tightness or length of the strap 934. In an alternative embodiment, the base member 938 may not be magnetic. Use of the mounting mechanism 930 is similar to that described for the mounting mechanism 900 illustrated in FIGS. 16 and 17, except the strap 934 may be adjusted to a desired length and tightness to secure the mounting mechanism 900 to the support surface.

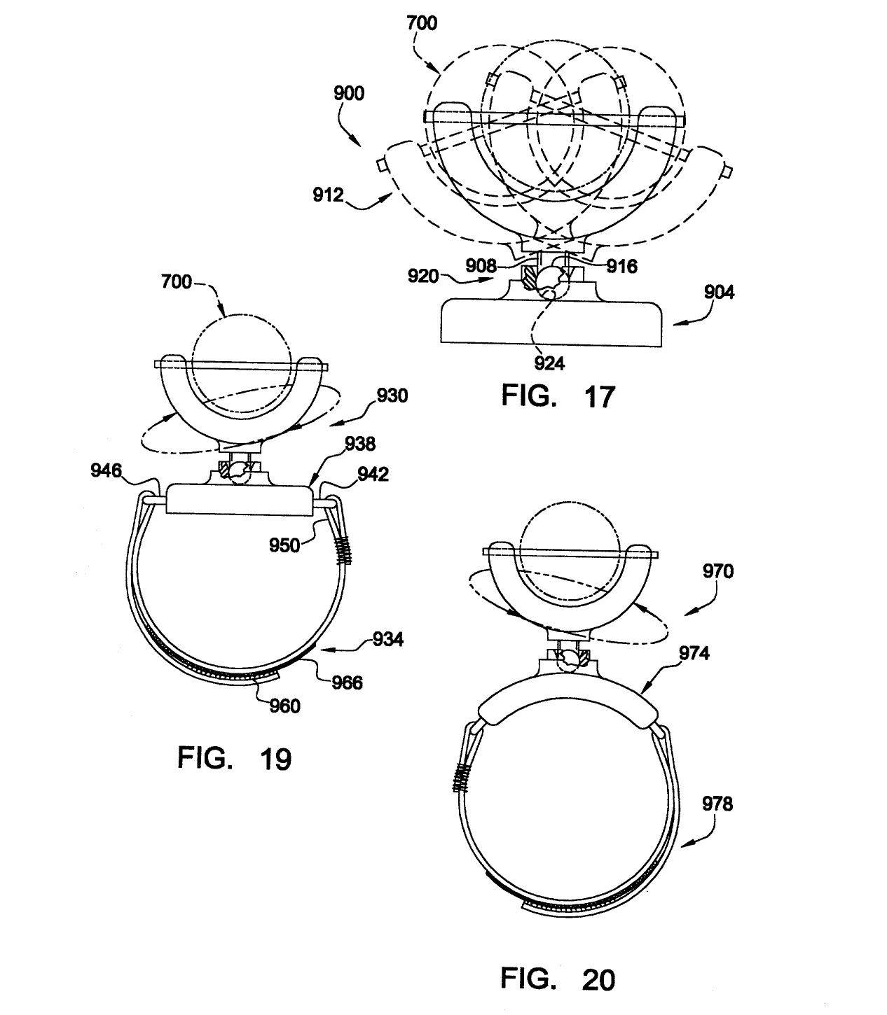

FIG. 20 illustrates an embodiment of a mounting mechanism 970 similar to the mounting mechanism 930 illustrated in FIG. 19, except the flat base member 938 is replaced with a slightly curved magnetic base member 974 for mounting the mounting mechanism 930 to a slightly curved support surface. Use of the mounting mechanism 970 is similar to that described for the mounting mechanism 930 illustrated in FIG. 18, except a strap 978 may be adjusted to a desired length and tightness to secure the mounting mechanism 970 to the support surface.

It will be readily apparent to those skilled in the art that still further changes and modifications in the actual concepts described herein can readily be made without departing from the spirit and scope of the invention as defined by the following claims.

What is claimed is:

1. A method of illuminating a work area for a tool, comprising the steps of:
providing a light housing and a mounting mechanism, the light housing including at least one LED and carried by the mounting mechanism;
mounting the mounting mechanism to at least one of a support surface of the tool and a support surface in the vicinity of the tool;
illuminating the work area with at least one LED of the tool light.

2. The method of claim 1, wherein the light housing is adapted to be used with a variety of different mounting mechanisms.

3. The method of claim 1, wherein the mounting mechanism is a dual-collar member having a first collar adapted to carry the light housing and a second collar adapted to mount to at least one of a support surface of the tool and a support surface in the vicinity of the tool.

4. The method of claim 3, wherein the second collar member is adjustable.

5. The method of claim 3, wherein the second collar member is magnetic, and the method further includes mounting the second collar member to at least one of a magnetically attractable tool and a magnetically attractable support surface through magnetic attraction.

6. The method of claim 5, wherein the second collar member is curved, and the method further includes mounting the curved second collar member to at least one of a curved tool and a curved support surface.

7. The method of claim 5, wherein the second collar member is flat, and the method further includes mounting the flat second collar member to at least one of a flat tool and a flat support surface.

8. The method of claim 5, wherein the second collar member further includes a strap, and the method further includes strapping the second collar member to at least one of a tool and the support surface using the strap.

9. The method of claim 3, wherein the second collar member is curved, and the method further includes mounting the curved second collar member to at least one of a curved tool and a curved support surface.

10. The method of claim 3, wherein the second collar member is flat, and the method further includes mounting the flat second collar member to at least one of a flat tool and a flat support surface.

11. The method of claim 3, wherein the second collar member further includes a strap, and the method further includes strapping the second collar member to at least one of a support surface of the tool and the support surface using the strap.

12. The method of claim 1, wherein the mounting mechanism is a rubber grommet having a first hole to receive the light housing and a second hole to receive a shaft of a tool, and the method further includes inserting the light housing through first hole and inserting the shaft of the tool through the second hole.

13. The method of claim 1, wherein the light housing is vertically adjustable, and the method further includes vertically adjusting the light housing.

14. The method of claim 1, wherein the light housing is horizontally adjustable, and the method further includes horizontally adjusting the light housing.

15. The method of claim 1, wherein mounting includes mounting the mounting mechanism to a handle of the tool.

16. The method of claim 1, wherein mounting includes mounting the mounting mechanism to a shaft of the tool

17. The method of claim 1, wherein mounting includes mounting the mounting mechanism to a support surface in the vicinity of the tool.

18. A tool light for illuminating a work area for a tool, comprising:
a mounting mechanism to be mounted to at least one of a support surface of the tool and a support surface in the vicinity of the tool; and
a light housing including at least one LED and at least one power source to power at least one LED to illuminate a work area for a tool, the light housing carried by the mounting mechanism.

19. The tool light of claim 18, wherein the light housing is adapted to be used with a variety of different mounting mechanisms.

20. The tool light of claim 18, wherein the mounting mechanism is a dual-collar member having a first collar adapted to carry the light housing and a second collar adapted to mount to at least one of a support surface of the tool and a support surface in the vicinity of the tool.

21. The tool light of claim 20, wherein the second collar member is adjustable.

22. The tool light of claim 20, wherein the second collar member is magnetic to mount the second collar member to at least one of a magnetically attractable tool and magnetically attractable support surface through magnetic attraction.

23. The tool light of claim 22, wherein the second collar member is curved to mount the curved second collar member to at least one of a curved tool and a curved support surface.

24. The tool light of claim 22, wherein the second collar member is flat to mount the flat second collar member to at least one of a flat tool and a flat support surface.

25. The tool light of claim 22, wherein the second collar member further includes a strap to strap the second collar member to at least one of a tool and a support surface using the strap.

26. The tool light of claim 20, wherein the second collar member is curved to mount the curved second collar member to at least one of a curved tool and a curved support surface.

27. The tool light of claim 20, wherein the second collar member is flat to mount the flat second collar member to at least one of a flat tool and a flat support surface.

28. The tool light of claim 20, wherein the second collar member further includes a strap to strap the second collar member to at least one of a tool and a support surface using the strap.

29. The tool light of claim 18, wherein the mounting mechanism is a rubber grommet having a first hole to receive the light housing and a second hole to receive a shaft of a tool.

30. The tool light of claim 18, wherein the light housing is vertically adjustable.

31. The tool light of claim 18, wherein the light housing is horizontally adjustable.

32. The tool light of claim 18, wherein the mounting mechanism is adapted to be mounted to a handle of the tool.

33. The tool light of claim 18, wherein the mounting mechanism is adapted to be mounted to a shaft of the tool.

34. The tool light of claim 18, wherein the mounting mechanism is adapted to be mounted to a support surface in the vicinity of the tool.
